(19) United States
(12) Patent Application Publication
(10) Pub. No.: US 2026/0176208 A1
(43) Pub. Date: Jun. 25, 2026

(54) CERAMIC SINTERED BODY AND PLASMA-GENERATING ELECTRODE

(71) Applicant: NITERRA CO., LTD., Nagoya-shi (JP)

(72) Inventors: Tsuneyuki ITO, Nagoya-shi (JP); Osamu YOSHIMOTO, Nagoya-shi (JP); Tomoo TANAKA, Nagoya-shi (JP)

(73) Assignee: NITERRA CO., LTD., Nagoya-shi (JP)

(21) Appl. No.: 18/989,989

(22) Filed: Dec. 20, 2024

(51) Int. Cl. C04B 35/56; H01B 1/04; H05H 1/24

(52) U.S. Cl. CPC C04B 35/5622; C04B 35/5611; C04B 35/5626; H01B 1/04; C04B 2235/3217; C04B 2235/3246; C04B 2235/3843; C04B 2235/3847; H05H 1/24

(57) ABSTRACT

A ceramic sintered body which contains a first particular element consisting of five or six elements selected from among titanium (Ti), vanadium (V), zirconium (Zr), niobium (Nb), molybdenum (Mo), hafnium (Hf), tantalum (Ta), and tungsten (W); a second particular element consisting of one element selected from yttrium (Y) and aluminum (Al); and elemental carbon (C). The total amount of the first particular element, the second particular element, and elemental carbon contained in the ceramic sintered body is 98 at % or more. The amount of the second particular element contained in the ceramic sintered body is 3,000 at. ppm or less. The amount of carbon contained in the ceramic sintered body is 45 at % or more and 55 at % or less. The ceramic sintered body has a single phase microstructure in which the first particular element forms a solid solution.

### BACKGROUND

### 1. Field of the Disclosure

The present disclosure relates to a ceramic sintered body and to an electrode for generating plasma (hereinafter referred to as a “plasma-generating electrode”).

### 2. Description of Related Art

There has hitherto been known a ceramic sintered body for use in a plasma-generating electrode (see, for example, Patent Document 1 and Non-Patent Document 1).
Patent Document 1: Japanese Patent No. 6929755
Non-Patent Document 1: Shiro Shimada, Michio Inagaki, Kunihito Matsui, “Oxidation Kinetics of Hafnium Carbide in the Temperature Range of 480 degrees to 600 degrees Celsius,” Journal of the American Ceramic Society, Volume 75, Issue 10, October 1992, Pages 2671-2678, [Retrieved on May 9, 1923], URL <https://doi.org/10.1111/j.1151-2916.1992.tb05487.x>

However, even when a related technique as disclosed in Patent Document 1 or Non-Patent Document 1 is employed, there is a need for improving oxidation resistance of a ceramic sintered body.

Thus, an object of the present disclosure is to provide techniques for improving oxidation resistance of a ceramic sintered body.

### BRIEF SUMMARY OF THE DISCLOSURE

The present disclosure has been accomplished in order to at least partially solve the aforementioned problem, and can be carried out in the following aspects.

In one aspect of the present disclosure, there is provided a ceramic sintered body. The ceramic sintered body contains a first particular element consisting of five or six elements selected from among titanium (Ti), vanadium (V), zirconium (Zr), niobium (Nb), molybdenum (Mo), hafnium (Hf), tantalum (Ta), and tungsten (W); a second particular element consisting of one element selected from yttrium (Y) and aluminum (Al); and elemental carbon (C). The total amount of the first particular element, the second particular element, and elemental carbon contained in the ceramic sintered body is 98 at % or more. The amount of the second particular element contained in the ceramic sintered body is 3,000 atomic ppm (hereinafter denoted by “at. ppm”) or less. The amount of carbon contained in the ceramic sintered body is 45 at % or more and 55 at % or less. The ceramic sintered body has a single phase microstructure in which the first particular element forms a solid solution.

According to this aspect, the ceramic sintered body has a single phase microstructure in which the first particular element forms a solid solution, the first particular element consisting of five or six elements selected from among titanium, vanadium, zirconium, niobium, molybdenum, hafnium, tantalum, and tungsten. Thus, oxidation resistance of the ceramic sintered body can be enhanced.

In the ceramic sintered body of the above aspect, the first particular element may contain zirconium. Accordingly, the ceramic sintered body contains, as the first particular element, zirconium, which has an ionic radius greater than any of titanium, vanadium, niobium, molybdenum, hafnium, tantalum, and tungsten. Thus, the strain of the crystal lattice in the single phase microstructure in which the first particular element forms solid solution increases. As a result, oxidation of the ceramic sintered body is prevented, whereby oxidation resistance of the ceramic sintered body can be further enhanced.

In the ceramic sintered body of the above aspect, the ceramic sintered body may have an elemental iron (Fe) content of 800 at. ppm or less. Accordingly, the ceramic sintered body has an elemental iron concentration of 800 at. ppm or less, and deposition of iron-based grains is suppressed. Thus, melting of the ceramic sintered body due to a rise in temperature is suppressed, whereby weight loss of the ceramic sintered body in use thereof can be suppressed.

In another aspect of the present disclosure, a plasma-generating electrode is provided. The plasma-generating electrode has the ceramic sintered body of the aforementioned aspect. Accordingly, the plasma-generating electrode has a ceramic sintered body having a single phase microstructure in which the first particular element forms solid solution. Thus, oxidation resistance of the plasma-generating electrode can be enhanced, whereby service life of the plasma-generating electrode can be prolonged.

The present disclosure can be realized in a variety of aspects. For example, the disclosure can be realized as a method for producing a ceramic sintered body, an apparatus having the ceramic sintered body, a method for regulating the apparatus having the ceramic sintered body, or the like.

Additional features and advantages of the present disclosure may be described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### BRIEF DESCRIPTION OF THE DRAWINGS

The figures contained herein are provided only by way of example and not by way of limitation.

FIG. 1 is a cross-section of a plasma-generating electrode having a ceramic sintered body of a first embodiment;

FIG. 2 is a first table showing conditions for fabricating samples of the ceramic sintered body;

FIG. 3 is a second table showing conditions for fabricating samples of the ceramic sintered body;

FIG. 4 is a first table showing characteristics of a sample of the ceramic sintered body; and

FIG. 5 is a second table showing characteristics of a sample of the ceramic sintered body.

### DETAILED DESCRIPTION OF THE DISCLOSURE

### First Example Embodiment

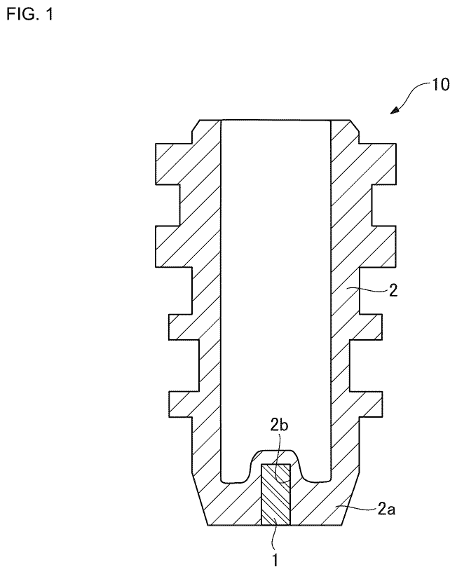

FIG. 1 is a cross-section of a plasma-generating electrode 10 having an electrode tip 1 (ceramic sintered body) of the present embodiment. The plasma-generating electrode 10 of the present embodiment is employed for, for example, generating oxygen plasma, in an apparatus employing plasma such as a plasma cutting machine, a plasma surface-treatment device, or a plasma spraying device. The plasma-generating electrode 10 has the electrode tip 1 serving as a cathode for generating plasma, and a tip-supporting portion 2 for supporting the electrode tip 1.

The electrode tip 1 is formed of a ceramic sintered body and contains a first particular element consisting of five or six elements selected from among titanium (Ti), vanadium (V), zirconium (Zr), niobium (Nb), molybdenum (Mo), hafnium (Hf), tantalum (Ta), and tungsten (W); a second particular element consisting of one element selected from yttrium (Y) and aluminum (Al); and elemental carbon (C). The total amount of the first particular element, the second particular element, and elemental carbon, which are contained in the electrode tip 1, is 98 at % or more, and the amount of the second particular element is 3,000 at. ppm or less. The total amount of the first particular element, the second particular element, and elemental carbon may be 100 at %, and the amount of the second particular element is greater than 0 at. ppm. The electrode tip 1 contains elemental carbon in an amount of 45 at % or more and 55 at % or less. The first particular element atomic concentration and the elemental carbon concentration of the electrode tip 1 are determined through energy dispersive X-ray spectrometry (EDS). The characterization of the second particular element present in the electrode tip 1, and determination of the second particular element atomic concentration are conducted by means of an inductively coupled plasma (ICP) optical emission spectrometer.

The electrode tip 1 of the present embodiment has a single phase microstructure in which the first particular element forms a solid solution. In the present embodiment, whether or not the electrode tip 1 has a single phase microstructure in which the first particular element forms a solid solution is determined through X-ray diffractometry by means of an X-ray diffractometer. Specifically, in a crystal structure analysis of the electrode tip 1 through X-ray diffractometry with a CuKα 1 ray within a 2-theta range of 20 degrees to 80 degrees, when only one peak attributed to each of <111> orientation, <200> orientation, <220> orientation, <311> orientation, and <222> orientation of the NaCl-type structure is present in each of the ranges of 30.0 degrees to 37.2 degrees, 34.8 degrees to 43.1 degrees, 50.2 degrees to 62.3 degrees, 59.7 degrees to 74.4 degrees, and 62.7 degrees to 78.5 degrees, the electrode tip 1 is determined to have a single phase microstructure. Notably, when two or three peaks are observed in any of the ranges of 30.0 degrees to 37.2 degrees, 34.8 degrees to 43.1 degrees, 50.2 degrees to 62.3 degrees, 59.7 degrees to 74.4 degrees, and 62.7 degrees to 78.5 degrees, the electrode tip 1 is determined to have a multi-phase microstructure.

The electrode tip 1 of the example embodiment contains, as the first particular element, five elements consisting of among titanium, zirconium, niobium, hafnium, and tantalum. Preferably, the electrode tip 1 contains, for example, as a combination of the first particular elements, titanium, zirconium, hafnium, and tantalum. The electrode tip 1 may contain, for example, as a combination of the first particular elements, zirconium and hafnium; more preferably zirconium, hafnium, and tantalum; and still more preferably zirconium, hafnium, tantalum, and titanium.

When the electrode tip 1 has, for example, a zirconium element concentration of at least 8.43 at %, the electrode tip 1 is resistant to oxidation in an atmosphere including oxygen plasma. The ceramic sintered body employed in the electrode tip 1 contains yttrium as the second particular element.

The electrode tip 1 of the present embodiment may contain elemental iron as an unavoidable impurity. The amount of elemental iron (Fe) may be included in the electrode tip 1 in a content of 800 at. ppm or less. Further, the elemental iron content of the electrode tip 1 may be 0 at. ppm.

Since the electrode tip 1 of the present embodiment has a single phase microstructure in which the first particular element forms a solid solution, the tip assumes a relatively dense ceramic sintered body having a small number of pores. The density of the ceramic sintered body is represented by a theoretical density calculated from lattice constants obtained through Riedvelt analysis, and a relative density calculated from specific weight and porosity as measured in accordance with JIS R1634. The electrode tip 1 of the present embodiment may have a relative density greater than 97%.

In the electrode tip 1 of the present embodiment, the difference in first particular element atomic concentration between individual elements is smaller than 5 at % (that is, each of the elements of the first particular element are individually contained in the same or similar amount). Thus, a single phase microstructure including a solid solution is easily formed. In the present embodiment, the difference in first particular element atomic concentration between individual elements is determined on the basis of the calculated compositional proportions in crystal grains through energy dispersive X-ray spectrometry.

The tip-supporting portion 2 is a bottomed tubular member and may be formed by, for example, working a copper rod member. The bottom portion 2a of the tip-supporting portion 2 is provided with a hole 2b in which the electrode tip 1 is to be inserted. Fabrication of the plasma-generating electrode 10 of the present embodiment may be completed by embedding the electrode tip 1 in the hole 2b of the tip-supporting portion 2.

Next, an example method for producing the electrode tip 1 of this example embodiment will be described.

In the electrode tip 1 production method, firstly, weighed metallic powders are put into a ball mill with ethanol and pulverized for 20 hours under mixing, to thereby prepare a metallic powder mixture. The weighed metallic powders are as follows: titanium carbide powder (mean particle size: 1.7 micrometers), zirconium carbide powder (mean particle size: 2.4 micrometers), niobium carbide powder (mean particle size: 1.1 micrometers), hafnium carbide powder (mean particle size: 0.7 micrometers), and tantalum carbide powder (mean particle size: 1.0 micrometer). These powders are weighed so that the amount of each component is adjusted to 20 mol % in the prepared metallic powder mixture. Subsequently, zirconia partially stabilized with 3 mol % yttria (Y₂O₃) (hereinafter referred to as “3YSZ”) is added to the metallic powder mixture in an amount equivalent to 0.4 wt % with respect to the thus-prepared metallic powder mixture, and the resultant mixture is pulverized under mixing for 20 hours, to thereby prepare a slurry. The thus-prepared slurry is dried by means of a hot water bath, to thereby yield a dry powder. The thus-prepared dry powder is passed through a sieve (opening: 100 micrometers), to thereby form a granulated powder. The granulated powder is put into a hot-press mold, and fired in vacuum at a firing temperature of 1,900 degrees Celsius under pressing at a pressure of 30 MPa. Thus, fabrication of the electrode tip 1 is completed.

Next will be described a test for evaluating the ceramic sintered body serving as an electrode tip for use in a plasma-generating electrode. In the evaluation test, a plurality of ceramic sintered bodies are fabricated under different conditions. The effects of fabrication conditions on the characteristics of the ceramic sintered body are assessed.

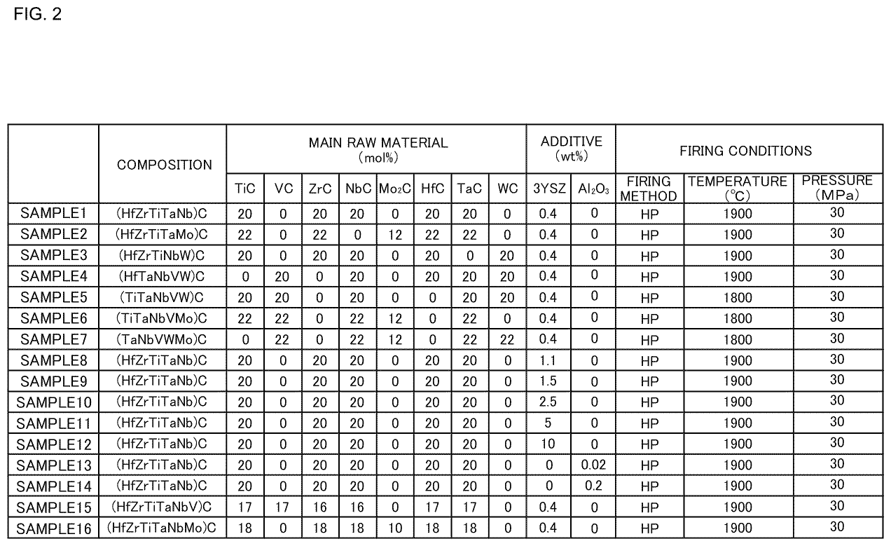

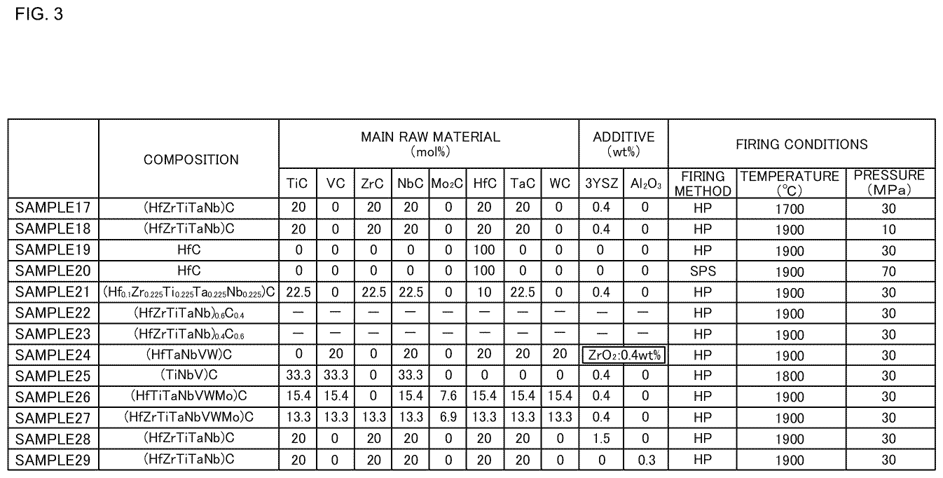

FIG. 2 is a first table showing conditions for fabricating samples of the ceramic sintered body. FIG. 3 is a second table showing conditions for fabricating samples of the ceramic sintered body. In the evaluation test, 29 samples of the ceramic sintered body; i.e., samples 1 to 29 were fabricated. FIGS. 2 and 3 show fabrication conditions for samples 1 to 29, individually. The conditions are “main raw material (type and mol %),” “additive (type and wt %),” and “firing conditions” including “firing technique,” “temperature (unit: degree Celsius),” and “pressure (unit: MPa).”

Firstly, the “main raw material” for providing the first particular element contained in the ceramic sintered body will be described. As shown in FIGS. 2 and 3, among samples 1 to 29, samples 1 to 21, and 24 to 29 were fabricated from 1 to 8 members of titanium carbide, vanadium carbide, zirconium carbide, niobium carbide, molybdenum carbide, hafnium carbide, tantalum carbide, and tungsten carbide, each of which is a “main raw material.” In preparation of samples 1 to 21, and 24 to 29, the following powders of “main raw material” having the following mean particle sizes were used.
Titanium carbide powder: 1.7 micrometers
Vanadium carbide powder: 1.8 micrometers
Zirconium carbide powder: 2.4 micrometers
Niobium carbide powder: 1.1 micrometers
Molybdenum carbide powder: 1.8 micrometers
Hafnium carbide powder: 0.7 micrometers
Tantalum carbide powder: 1.0 micrometer
Tungsten carbide powder: 1.1 micrometers

Next, the “additive” for providing the second particular element contained in the ceramic sintered body will be described. As shown in FIGS. 2 and 3, in preparation of samples 1 to 21, and 24 to 29, 3YSZ or aluminum oxide (Al₂O₃) was used as an “additive.” In preparation of samples 1 to 21, and 24 to 29, the following powders of “additive” having the following mean particle sizes were used. Notably, in preparation of sample 24, 0.4 wt % zirconia (ZrO₂) was used as an “additive.” Details of raw materials for preparing samples 22 and 23 are described below.
3YSZ: 1.0 micrometer
Al₂O₃: 0.3 micrometers

Similar to the method for fabricating the electrode tip 1, in preparation of samples 1 to 21, and 24 to 29, metallic powder mixtures were prepared. In preparation of the metallic powder mixtures, materials were weighed so as to adjust the values (mol %) of “main raw material” in the metallic powder mixtures to those shown in FIGS. 2 and 3. The weighed metallic powders were put into a ball mill with ethanol and pulverized for 20 hours under mixing. In the case of sample 25, titanium carbide, vanadium carbide, and niobium carbide were each weighed in an equal amount so as to adjust the total amount of the main raw material to about 100 mol %, and the carbides were put into a ball mill with ethanol and pulverized for 20 hours under mixing. In the cases of samples 1 to 21, and 25 to 29, a relevant “additive” was added to each of the prepared metallic powder mixtures in an amount corresponding to a value specified in FIGS. 2 and 3 with respect to the weight of the metallic powder mixture. The resultant mixture was subjected to pulverization for 20 hours under mixing, to thereby prepare a slurry. In the case of sample 24, zirconia was added as an “additive” to the prepared metallic powder mixture in an amount corresponding to 0.4 wt % with respect to the metallic powder mixture, and pulverization was conducted for 20 hours under mixing, to thereby prepare a slurry. In the cases of samples 1 to 21, and 24 to 29, each of the thus-prepared slurries was dried by means of a hot water bath, to thereby yield each dry powder. The thus-prepared dry powder was passed through a sieve (opening: 100 micrometers), to thereby form a granulated powder.

Among samples 1 to 21, and 24 to 29, in preparation of samples 1 to 19, 21, and 24 to 29, firing was conducted through hot pressing (HP) as specified in “firing conditions” and “firing method” of FIGS. 2 and 3. In preparation of samples 1 to 19, 21, and 24 to 29, the obtained granulated powder was put into a square hot press mold (30 mm×30 mm) so as to adjust the thickness of the sample to 20 mm, and firing was conducted in vacuum under the conditions as specified in “firing conditions,” “firing temperature,” and “firing pressure” of FIGS. 2 and 3.

Among samples 1 to 21, and 24 to 29, in preparation of sample 20, firing was conducted through spark plasma sintering (SPS) as specified in “firing conditions” and “firing method” of FIG. 3. Specifically, in preparation of sample 20, the obtained granulated powder was put into a mold (diameter: 10 mm) for spark plasma sintering so as to adjust the thickness of the sample to 10 mm, and firing was conducted in vacuum at a firing temperature of 1,900 degrees Celsius and a pressure of 70 MPa.

In preparation of samples 22 and 23, there were used metal oxides; hafnium oxide (HfO₂), zirconium oxide (ZrO₂), titanium oxide (TiO₂), tantalum oxide (Ta₂O₅), niobium oxide (Nb₂O₅), and carbon (C) as raw materials. In preparation of samples 22 and 23, the following material powders having the following mean particle sizes were used.
hafnium oxide powder: 2.0 micrometers
zirconium oxide powder: 1.0 micrometer
titanium oxide powder: 1.0 micrometer
tantalum oxide powder: 3.0 micrometers
niobium oxide powder: 1.0 micrometer
carbon powder: 5.0 micrometers

In preparation of sample 22, the aforementioned raw materials were weighed so as to attain a composition (HfZrTiTaNb)_{0.6}C_{0.4}. In preparation of sample 23, the aforementioned raw materials were weighed so as to attain a composition (HfZrTiTaNb)_{0.4}C_{0.6}. In preparation of samples 22 and 23, the weighed raw materials were mixed by means of a ball mill, and the resultant powder was subjected to a heat treatment in vacuum at 1,600 degrees Celsius for 3 hours. Thereafter, the obtained powder was put into a square hot press mold (30 mm×30 mm) so as to adjust the thickness of the sample to 20 mm, and firing was conducted in vacuum under at a firing temperature of 1,900 degrees Celsius and a pressure of 30 MPa.

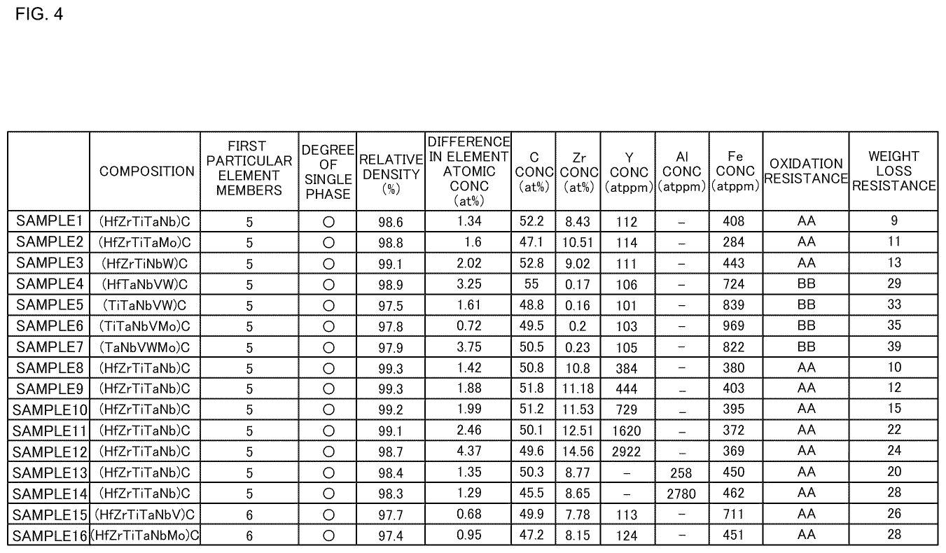

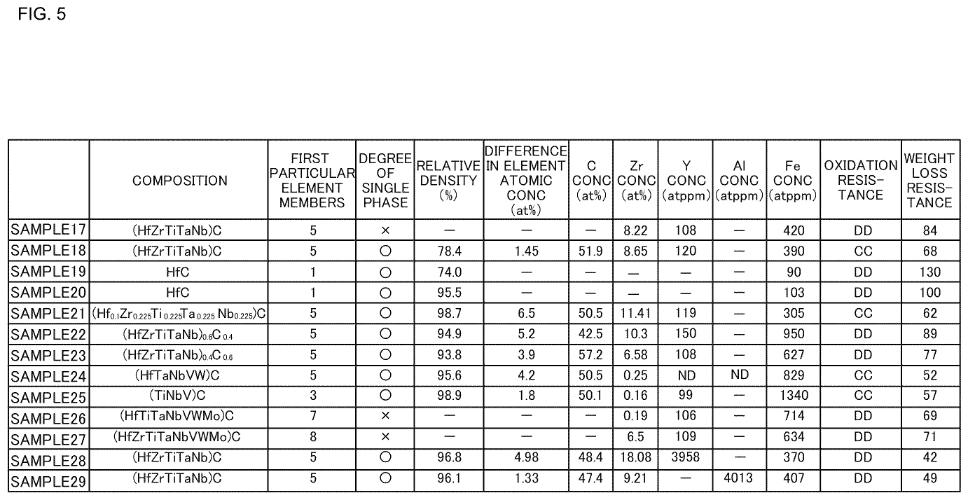

FIG. 4 is a first table showing characteristics of a sample of the ceramic sintered body. FIG. 5 is a second table showing characteristics of a sample of the ceramic sintered body. Specifically, FIG. 4 shows the number of atoms (elements) corresponding to the first particular element, and characteristics of a sample as determined through various techniques, of samples 1 to 16. FIG. 5 shows the number of atoms (elements) corresponding to the first particular element, and characteristics of a sample as determined through various techniques, of samples 17 to 29. Now, methods for determining characteristics of a sample shown in FIGS. 4 and 5 will be described. In the assessment, mirror-polished samples were employed. Notably, in relation to characteristics shown in FIGS. 4 and 5, the item not measured is denoted as “-,” and the case in which the measurement was below detection limit is denoted as “ND.”

The “degree of single phase” (i.e., whether or not the ceramic sintered body includes a single phase microstructure) was determined by identifying the crystal phase of the sample through X-ray diffractometry by means of an X-ray diffractometer. Specifically, similar to the method for characterizing the electrode tip 1, in crystal structure analysis of a sample through X-ray diffractometry with CuKα 1 ray, when only one peak attributed to each of <111> orientation, <200> orientation, <220> orientation, <311> orientation, and <222> orientation of the NaCl-type structure was present in each of the ranges of 30.0 degrees to 37.2 degrees, 34.8 degrees to 43.1 degrees, 50.2 degrees to 62.3 degrees, 59.7 degrees to 74.4 degrees, and 62.7 degrees to 78.5 degrees, the sample was determined to have a single phase microstructure. The relative density of the sample found to have a single phase was calculated from a theoretical density calculated from lattice constants obtained through Riedvelt analysis, and a specific weight and porosity as measured in accordance with JIS R1634.

The “atomic concentration difference” represents the difference in atomic concentration between individual elements contained in each sample. The “C concentration” represents an elemental carbon concentration of a sample. The “atomic concentration difference in first particular elements” and the “C concentration” were calculated from the compositional proportions in the crystal grains determined through energy-dispersive X-ray spectrometry.

The terms “Zr concentration,” “Y concentration,” “Al concentration,” and “Fe concentration” represent the zirconium element concentration, yttrium element concentration, aluminum element concentration, and elemental iron concentration of a sample, respectively. In the present assessment, the presence of elemental yttrium or elemental aluminum in the sample was confirmed by means of an inductively coupled plasma optical emission spectrometer. Also, “Zr concentration,” “Y concentration,” “Al concentration,” and “Fe concentration” were determined in the same manner.

“Oxidation resistance” was determined by means of a high-frequency plasma etching apparatus. Specifically, an etching process was conducted in a reduced-pressure oxygen atmosphere in which the oxygen content was adjusted to achieve a pressure of 30 Pa. High-frequency plasma (output: 100 W) was applied to a sample for 30 minutes. After the etching process, the compositional proportions of the sample were calculated through energy-dispersive X-ray spectrometry. The sample was assessed on the variation in carbon amount and that in oxygen amount of the sample before and after the etching process. The ratings of “oxidation resistance” of the sample are as follows.
“AA”: amount of carbon decrease of 2 at % or more, or amount of oxygen increase of 4 at % or more
“BB”: amount of carbon decrease of 3 at % or more, or amount of oxygen increase of 6 at % or more
“CC”: amount of carbon decrease of 4 at % or more, or amount of oxygen increase of 8 at % or more
“DD”: amount of carbon decrease of 6 at % or more, or amount of oxygen increase of 10 at % or more

“Weight loss resistance” represents the degree of loss in weight of a ceramic sintered body sample when it is used as a plasma-generating electrode. Specifically, the ceramic sintered body sample was processed to an electrode for evaluation (diameter: 1 mm, length: 10 mm). The evaluation electrode was employed as a cathode, and an anode was grounded. While the cathode was connected to a DC pulse power source, the evaluation electrode was subjected to plasma discharge at a power 300 W for 3 hours in an atmosphere in which a gas mixture of nitrogen and oxygen was present. After electric discharge, the weight loss of the evaluation electrode was measured, whereby the amount of loss of the evaluation electrode was calculated. In the present evaluation test, the “amount of loss” of each of samples 1 to 21, and 25 to 29 is a relative value with respect to the amount of loss of sample 20 as 100. In other words, the smaller the “weight loss resistance” shown in FIGS. 4 and 5, the higher the resistance to weight loss.

Each of samples 1 to 16 shown in FIG. 4 contained five or six members of the first particular element, and a single phase was found to be confirmed. Also, samples 1 to 16 had a relative density higher than 97%, and the difference in atomic concentration was less than 5 at %. Further, samples 1 to 16 had an elemental carbon concentration of 45 at % or more and 55 at % or less and a yttrium element concentration or an aluminum element concentration of 3,000 at. ppm or less.

Samples 1 to 16 each contained a zirconium element. As shown in FIG. 4, the samples each exhibited oxidation resistance of “AA” or “BB.” Thus, the samples were found to exhibit an oxidation resistance higher than that of the below-mentioned samples 17 to 29 shown in FIG. 5. Among samples 1 to 16, when samples 1 to 3, and 8 to 16 having a relatively high zirconium element concentration was compared with samples 4 to 7 having a relatively low zirconium element concentration, samples 1 to 3, and 8 to 16 having a relatively high zirconium element concentration were found to exhibit a further enhanced oxidation resistance.

Samples 1 to 16 each contained elemental iron as an impurity. However, the impurity concentration was merely 800 at. ppm or lower. The resistance to weight loss of each of samples 1 to 16 was 40 or less, which was a relatively small value. Thus, samples 1 to 16 were found to exhibit a weight loss resistance higher than that of samples 17 to 29 shown in FIG. 5. Among samples 1 to 16, when samples 1 to 3, and 8 to 16 having a relatively low elemental iron concentration are compared with samples 4 to 7 having a relatively high elemental iron concentration, samples 1 to 3, and 8 to 16 having a relatively low elemental iron concentration are found to exhibit a further enhanced resistance to weight loss.

Samples 17 to 29 shown in FIG. 5 were found to be inferior to samples 1 to 16 in terms of oxidation resistance and weight loss resistance. The difference in individual characteristics between samples 17 to 29 and samples 1 to 16 will be described.

Sample 17 was fired at 1,700 degree Celsius, which was a temperature lower than the firing temperature for preparing samples 1 to 16 (see FIG. 3). As a result, no single phase microstructure was provided. Thus, sample 17 exhibited low oxidation resistance. When sample 17 is employed as a plasma-generating electrode for generating oxygen plasma, oxidation easily proceeds. In conclusion, sample 17 may have a short service life for serving as a plasma-generating electrode.

In firing, sample 18 was pressed at 10 MPa, which was lower than the pressure applied in firing to prepare samples 1 to 16 (see FIG. 3), and was provided with more pores than those of samples 1 to 16. Thus, the relative density of sample 18 was lower than that of samples 1 to 16. As a result, sample 18 readily generates heat by the mediation of electric resistance and may exhibit a short service life for serving as a plasma-generating electrode.

Sample 19 was prepared only from hafnium carbide as a “main raw material” (see FIG. 3). Since hafnium carbide is easily oxidized in an oxygen atmosphere even at a relatively low temperature, the rating of oxidation resistance was “DD.” In addition, since hafnium carbide is a high-melting-point material, difficulty is encountered in sintering. Thus, sample 19, prepared through hot pressing (see FIG. 3), has a number of pores (i.e., a relatively low relative density) and is not formed at high density. Therefore, sample 19 exhibits low weight loss resistance and readily undergoes weight loss.

Similar to sample 19, sample 20 was prepared only from hafnium carbide as a “main raw material,” but was prepared through “spark plasma sintering (SPS)” (see FIG. 3). As a result, sample 20 was formed at a density higher than that of sample 19. That is, sample 20 has a higher relative density. As compared with sample 19, the weight loss resistance of sample 20 is enhanced. However, as mentioned above, the rating of oxidation resistance was “DD” due to high oxidizability of hafnium carbide.

Sample 21 has a compositional formula (Hf_{0.1}Zr_{0.225}Ti_{0.225}Ta_{0.225}Nb_{0.225})C. Thus, the atomic concentration difference of sample 21 is 6.5 at %, which is greater than the upper limit (5 at %) of the atomic concentration difference of samples 1 to 16. When the atomic concentration difference exceeds 5 at %, difficulty is encountered in formation of a single phase microstructure in which a solid solution is formed. When the sample is employed as a plasma-generating electrode for generating oxygen plasma, oxidation easily proceeds. Thus, the service life for serving as a plasma-generating electrode may be shortened.

Sample 22 was formed from oxides of the first particular element and carbon as raw materials. Sample 22 has a compositional formula (HfZrTiTaNb)_{0.6}C_{0.4}. The atomic carbon element concentration of sample 22 is 42.5 at %, which is smaller than the lower limit (45 at %) of the carbon element concentration of samples 1 to 16. Thus, in sample 22, a metal phase originating from the first particular element is easily deposited. Since such a metal phase has a melting point lower than that of a carbide, sample 22 is readily melted at a temperature for use as a plasma-generating electrode. Thus, the service life for serving as a plasma-generating electrode may be shortened.

Sample 23 was formed from oxides of the first particular element and carbon as raw materials. Sample 23 has a compositional formula (HfZrTiTaNb)_{0.4}C_{0.6}. Sample 23 has an elemental carbon concentration of 57.2 at %, which is higher than that the upper limit of the elemental carbon concentration (55 at %) of samples 1 to 16. Thus, free carbon is easily deposited, and electric discharge initiation voltage rises in use as a plasma-generating electrode. In this case, the temperature of the plasma-generating electrode itself rises, readily resulting in melting. Thus, the service life for serving as a plasma-generating electrode may be shortened.

Sample 24 was prepared from zirconia as an additive instead of 3YSZ or Al₂O₃. That is, sample 24 contains no yttrium or aluminum. In the case where a sample containing no yttrium or aluminum, when the sample is employed as a plasma-generating electrode, electric discharge initiation voltage rises, readily resulting in melting. In this case, the service life of the plasma-generating electrode may be shortened.

Sample 25 has a compositional formula (TiNbV)C. In other words, differing from samples 1 to 16 including 5 or 6 members of the first particular element, sample 25 includes three members thereof. In addition, sample 25 has an elemental iron concentration of 1,340 at. ppm %, which is higher than that the upper limit of the elemental iron concentration (800 at. ppm) of samples 1 to 16. When the elemental iron concentration exceeds 800 at. ppm, coarse iron-based grains are readily deposited. Such iron-based grains have a low melting point and are readily melted at a temperature for use as a plasma-generating electrode. Thus, the service life for serving as a plasma-generating electrode may be shortened.

Sample 26 has a compositional formula (HfTiTaNbVWMo)C. In other words, differing from samples 1 to 16 including 5 or 6 of members of the first particular element, sample 26 includes 7 members thereof and no single phase microstructure. Similar to sample 17, when sample 26 is employed as a plasma-generating electrode for generating oxygen plasma, oxidation easily proceeds. Thus, the service life for serving as a plasma-generating electrode may be shortened.

Sample 27 has a compositional formula (HfZrTiTaNbVWMo)C. In other words, differing from samples 1 to 16 including 5 or 6 members of the first particular element, sample 27 includes 8 members thereof and no single phase microstructure. As a result, similar to sample 26, when sample 27 is employed as a plasma-generating electrode for generating oxygen plasma, oxidation easily proceeds. Thus, the service life for serving as a plasma-generating electrode may be shortened.

Sample 28 contains 1.5 wt % 3YSZ as an additive (see FIG. 3). Thus, sample 28 has a yttrium element concentration of 3,958 at. ppm, which is higher than the upper limit of the yttrium element concentration (3,000 at. ppm) of samples 1 to 16. Sample 29 contains 0.3 wt % aluminum oxide as an additive (see FIG. 3). Thus, sample 29 has an aluminum element concentration of 4,013 at. ppm, which is higher than the upper limit of the aluminum element concentration (3,000 at. ppm) of samples 1 to 16. When the yttrium element concentration or the aluminum element concentration exceeds 3,000 at. ppm, yttrium or aluminum is easily deposited at the crystal grain boundary of a ceramic sintered body, and element concentrations of a single phase microstructure in which a solid solution is formed easily vary. Thus, when sample 28 or 29 is employed as a plasma-generating electrode for generating oxygen plasma, oxidation easily proceeds. Thus, the service life for serving as a plasma-generating electrode may be shortened.

Sample 28 has a zirconium element concentration of 18.08 at %, which is higher than that of samples 1 to 16 (15 at %). In the ceramic sintered body, when the zirconium element concentration exceeds 15 at %, a multi-phase microstructure containing zirconium is formed, and the first particular element concentration distribution in grains of a single phase microstructure containing the first particular element becomes uneven. Thus, when sample 28 is employed as a plasma-generating electrode for generating oxygen plasma, oxidation easily proceeds. Thus, the service life for serving as a plasma-generating electrode may be shortened.

In an apparatus employing plasma such as a plasma cutting machine or a plasma surface-treatment device, in some cases, the plasma-generating electrode is formed of a high melting metallic material such as hafnium, zirconium, or tungsten. However, heat generation of the plasma-generating electrode itself due to maintenance of high plasma arc current, oxidation by plasma gas species (e.g., oxygen), or other conditions result in easy weight loss of the plasma-generating electrode. Thus, the service life of the plasma-generating electrode may be somewhat shortened. To cope with this, the plasma-generating electrode is formed from hafnium carbide, which is a material having a higher melting point, in some cases. However, as mentioned also in relation to the aforementioned samples 19 and 20, hafnium carbide readily undergoes oxidation in an oxygen atmosphere even at a relatively low temperature. Therefore, there is concern about shortening of the service life of the electrode made of hafnium carbide due to oxidation in an oxygen-containing plasma atmosphere. Also, difficulty is encountered in sintering of hafnium carbide. In order to yield a large-scale hafnium carbide sintered body, considerably high voltage is needed. Thus, hitherto, production of a dense hafnium carbide sintered body was successfully achieved only through spark plasma sintering, leading to easily increasing costs for apparatus and production. Further, since uniform sintering is difficult in spark plasma sintering, dimensional flexibility is limited.

The ceramic sintered body employed in the electrode tip 1 of the present embodiment contains titanium, zirconium, niobium, hafnium, and tantalum (first particular element); yttrium (second particular element), and elemental carbon. When a single phase microstructure in which a solid solution of five members of first particular element is provided in the ceramic sintered body, oxidation is suppressed in, for example, an atmosphere containing oxygen plasma. Also, since the first particular element includes an element having a melting point lower than that of hafnium carbide, a dense ceramic sintered body can be fabricated through a sintering method such as hot pressing. As a result, the ceramic sintered body employed in the electrode tip 1 of the present embodiment can be provided with a complex shape, while costs for apparatus and production are reduced. In addition, the service life of the electrode tip 1 can be prolonged as compared with an electrode tip formed of hafnium or hafnium carbide.

The ceramic sintered body which has been described above and which is included in the electrode tip 1 of the present embodiment has a single phase microstructure in which the first particular element forms a solid solution, the particular element consisting of five or six elements selected from among titanium, vanadium, zirconium, niobium, molybdenum, hafnium, tantalum, and tungsten. As a result, oxidation resistance of the ceramic sintered body employed in the electrode tip 1 can be enhanced.

In the ceramic sintered body employed in the electrode tip 1 of the present embodiment, the first particular element may include zirconium. Thus, the strain of the crystal lattice in the single phase microstructure in which the first particular element forms solid solution increases. As a result, oxidation of the ceramic sintered body employed in the electrode tip 1 is prevented, whereby oxidation resistance of the ceramic sintered body can be further enhanced.

Also, in the ceramic sintered body employed in the electrode tip 1 of the present embodiment, the elemental iron concentration may be 800 at. ppm or lower. Thus, deposition of coarse iron-based grains is suppressed. As a result, melting concomitant with a rise in temperature of ceramic sintered body is suppressed, whereby weight loss of the ceramic sintered body due to operation can be suppressed. In conclusion, the service life of the electrode tip 1 can be prolonged.

The electrode tip 1 of the present embodiment includes a ceramic sintered body having a single phase microstructure in which the first particular element forms a solid solution, the particular element consisting of five or six elements selected from among titanium, vanadium, zirconium, niobium, molybdenum, hafnium, tantalum, and tungsten. Thus, oxidation resistance of the electrode tip 1 can be enhanced, whereby the service life of the plasma-generating electrode can be prolonged.

The electrode tip 1 of the present embodiment may be fabricated through hot pressing. Thus, as compared with a plasma-generating electrode formed of hafnium or hafnium carbide produced through spark plasma sintering, the electrode tip 1 can be provided with a complex shape, while costs for apparatus and production are reduced.

### MODIFICATION EXAMPLES OF THE PRESENT EMBODIMENT

The present disclosure is not limited to the above-described embodiment and can be implemented in various forms without departing from the gist of the present disclosure. For example, the following modifications are possible.

### Modification 1

In the aforementioned embodiment, the ceramic sintered body present in the electrode tip 1 contains, as the first particular element, five elements; i.e., titanium, zirconium, niobium, hafnium, and tantalum. However, the ceramic sintered body may contain five or six elements from among titanium, vanadium, zirconium, niobium, molybdenum, hafnium, tantalum, and tungsten.

### Modification 2

In the aforementioned embodiment, the electrode tip 1 contains, as a combination of members of the first particular, titanium, zirconium, hafnium, and tantalum. However, the combination of preferred members of the first particular element is not limited to the above combination. A combination of zirconium, hafnium, and tantalum is preferred. Even when zirconium and hafnium is used in combination, oxidation resistance of the electrode tip 1 can be further enhanced.

### Modification 3

In the aforementioned embodiment, the electrode tip 1 may have a zirconium element concentration of 8.43 at %. However, the member of the first particular element that can enhance oxidation resistance of the electrode tip 1 through incorporation thereinto is not limited to zirconium. Instead of zirconium, when hafnium, tantalum, titanium, or the like is incorporated into the electrode tip 1, oxidation resistance of the tip can also be enhanced.

### Modification 4

In the aforementioned embodiment, the elemental iron (Fe) concentration of the ceramic sintered body employed in the electrode tip 1 is adjusted to 800 at. ppm or lower. The elemental iron concentration may be higher than 800 at. ppm. However, when the elemental iron concentration increases, deposited iron-based grains melt, resulting in short service life. Thus, the elemental iron concentration is preferably lower. The elemental iron concentration may be lower than the detection limit in quantitation by means of an inductively coupled plasma optical emission spectrometer.

### Modification 5

The ceramic sintered body of the aforementioned embodiment has the electrode tip 1. However, the technical field to which the ceramic sintered body applies is not limited thereto. The ceramic sintered body may be employed in various fields where resistance to oxidation and loss is required.

The present disclosure has been described above with reference to the specific embodiments and modification example. However, the embodiment of the aforementioned disclosure is provided only for the purpose of easy understanding of the present disclosure, and should not be construed as limiting the disclosure. The present disclosure may be modified or improved, without deviating from the gist and the claims, and encompasses equivalents thereto. In addition, unless a technical feature is referred to as an essential element in the specification, it may be appropriately deleted.

### Application Example 1

A ceramic sintered body,
containing a first particular element consisting of five or six elements selected from among titanium (Ti), vanadium (V), zirconium (Zr), niobium (Nb), molybdenum (Mo), hafnium (Hf), tantalum (Ta), and tungsten (W);
a second particular element consisting of one element selected from yttrium (Y) and aluminum (Al); and
elemental carbon (C), wherein
the total amount of the first particular element, the second particular element, and elemental carbon contained in the ceramic sintered body is 98 at % or more;
the amount of the second particular element contained in the ceramic sintered body is 3,000 at. ppm or less;
the amount of carbon contained in the ceramic sintered body is 45 at % or more and 55 at % or less; and
the ceramic sintered body has a single phase microstructure in which the first particular element forms a solid solution.

### Application Example 2

A ceramic sintered body as described in Application Example 1, wherein
the first particular element includes zirconium.

### Application Example 3

A ceramic sintered body as described in Application Example 1 or 2,
which contains elemental iron (Fe) in an amount of 800 at. ppm or less.

### Application Example 4

A plasma-generating electrode
which has a ceramic sintered body as recited in any one of Application Examples 1 to 3.

The disclosure has been described in detail with reference to the above embodiments. However, the disclosure should not be construed as being limited thereto. It should further be apparent to those skilled in the art that various changes in form and detail of the disclosure as shown and described above may be made. It is intended that such changes be included within the spirit and scope of the claims appended hereto.

What is claimed is:

1. A ceramic sintered body comprising:
a first particular element consisting of five or six elements selected from among the group consisting of titanium (Ti), vanadium (V), zirconium (Zr), niobium (Nb), molybdenum (Mo), hafnium (Hf), tantalum (Ta), and tungsten (W);
a second particular element consisting of one element selected from the group consisting of yttrium (Y) and aluminum (Al); and
elemental carbon (C), wherein
a total amount of the first particular element, the second particular element, and elemental carbon contained in the ceramic sintered body is 98 at % or more;
an amount of the second particular element contained in the ceramic sintered body is 3,000 at. ppm or less;
an amount of carbon contained in the ceramic sintered body is 45 at % or more and 55 at % or less; and
the ceramic sintered body has a single phase microstructure in which the first particular element forms a solid solution.

2. The ceramic sintered body according to claim 1,
wherein the first particular element contains zirconium.

3. The ceramic sintered body according to claim 1,
which has an elemental iron (Fe) content of 800 at. ppm or less.

4. An electrode for generating plasma, the electrode comprising:
the electrode having a ceramic sintered body as recited in claim 1.

5. The ceramic sintered body according to claim 2,
which has an elemental iron (Fe) content of 800 at. ppm or less.

6. An electrode for generating plasma, the electrode comprising:
the electrode having a ceramic sintered body as recited in claim 2.

7. An electrode for generating plasma, the electrode comprising:
the electrode having a ceramic sintered body as recited in claim 3.

8. A electrode for generating plasma, the electrode comprising:
the electrode having a ceramic sintered body as recited in claim 5.
